(19) United States
(12) Patent Application Publication
(10) Pub. No.: US 2004/0082359 A1
(43) Pub. Date: Apr. 29, 2004

(54) Earprone system for mobile phone

(76) Inventors: Mun Choi, Seoul (KR); Chang-Su Bae, Seoul (KR)

Correspondence Address: Paul J Farrell, Dilworth & Barrese, 333 Earle Ovington Boulevard, Uniondale, NY, 11553, US

(21) Appl. No.: 10/433,726

(22) PCT Filed: Dec. 3, 2001
(86) PCT No.: PCT/KR01/02085

(30) Foreign Application Priority Data
Dec. 4, 2000 (KR) 2000/73147
Dec. 5, 2000 (KR) 2000/34117 U
Nov. 20, 2001 (KR) 2001/35739 U

(51) Int. Cl. H04M 1/00; H04B 1/38

(52) U.S. Cl. 455/556.1; 455/557; 455/575.2

(57) ABSTRACT

An earphone system for a mobile phone includes a jack coupled to the mobile phone, a speaker electrically connected to the jack, and a microphone electrically connected to the jack. The speaker and the microphone are inserted in one end of a nonconductive communication tube. The communication tube comprises a receiving tube for transmitting sound from the speaker to a user's ear and a transmission tube for transmitting user's transmission sound to the microphone.

### TECHNICAL FIELD

The present invention relates to an electron radiation reducing system for a mobile phone, and more particularly to a system for preventing the harmful electron radiation from being transmitted to the human body, thereby minimizing the damage by the electron radiation.

### BACKGROUND ART

Generally, electron devices or mobile phones inevitably generate electron radiation that is very harmful, causing the cancer.

Particularly, since the mobile phones closely contacts the human body such as the mouth and ears during the use thereof, the electron radiation is easily transmitted to the human body.

To solve these problems, as shown in FIG. 1, an earphone system usable with the mobile phone has been developed to reduce the transmission of the electron radiation to the human body.

The earphone system includes a necklace 100, a transmission part 101 mounted on the necklace 100 and a receiving part 102 connected to the transmission part 101 by an electric wire 103 to be receivable in the ear, a front end of the electric wire 103 being provided with a jack 104 formed to be connectable to the mobile phone. The transmission part 101 has a microphone and the receiving part 102 has a speaker.

Accordingly, in a state where the jack 104 is inserted into the mobile phone (not shown), the transmission sound is transmitted through the transmission part 101, and the receiving sound is received through the receiving part 102.

However, although the earphone can reduce the electron radiation generated from the mobile phone and transmitted to the user, the electron radiation generated from the transmission and receiving part is still transmitted to the user.

### DISCLOSURE OF INVENTION

Therefore, the present invention has been made in an effort to solve the above-described problems of the prior art.

It is an objective of the present invention to provide an electron radiation reducing system for a mobile phone that can reduce the electron radiation generated from a mobile phone and an earphone system associated with the mobile phone, thereby protecting the human body from the electron radiation.

It is another objective of the present invention to provide an earphone system for a mobile phone, which is designed to prevent the sound transmission and receiving from being cut.

To achieve the above objectives, the present invention provides an earphone system for a mobile phone, comprising a jack coupled to the mobile phone; a speaker electrically connected to the jack; and a microphone electrically connected to the jack, wherein the speaker and the microphone are inserted in one end of a nonconductive communication tube; and the communication tube comprises a receiving tube for transmitting sound from the speaker to a user's ear and a transmission tube for transmitting user's transmission sound to the microphone.

An ear inserter is formed on a front end of the receiving tube, a sound collecting plate is formed on a front end of the transmission tube. The communication tube is directly connected to receiving and transmission parts of the mobile phone.

According to another aspect, the present invention provides an earphone system for a mobile phone, comprising nonconductive rod tubes rotatably connected on corresponding positions to receiving and transmission parts that are formed on a main body of the mobile phone.

According to still another aspect, the present invention provides an earphone system for a mobile phone, comprising a jack coupled to the mobile phone; a speaker electrically connected to the jack; a microphone electrically connected to the jack; a receivable part for receiving the speaker and the microphone; a sound wave tube having receiving and transmission tubes communicating with the microphone and the speaker of the receivable part, respectively; and a communication tube connected to the transmission and receiving tubes and provided at its front end with receiving and transmission part.

The sound wave tube includes a first coupling part having a first insertion tube and a first hole, and the communication tube includes a second coupling part having a second insertion tube inserted into the first hole and a second hole in which the first insertion tube is inserted.

The first coupling part is provided with a hook groove and the second coupling part is provided with a hook hooked on the hook groove.

A spring is inserted inside or outside the communication tube. A spring is inserted outside or inside the sound wave tube.

The receiving part is provided with an ear hook member, and a partition is disposed inside the sound wave tube to define separated receiving tube and transmission tube.

### BRIEF DESCRIPTION OF DRAWINGS

FIG. 1 is a perspective view of a conventional earphone system applicable to a mobile phone;

FIG. 2 is a partly sectional view of an earphone systemfor a mobile phone according to a first embodiment of the present invention;

FIG. 3 is a perspective view of an earphone systemfor a mobile phone according to a second embodiment of the present invention;

FIG. 4 is a perspective view illustrating an applied state of FIG. 3;

FIG. 5 is a view illustrating an earphone systemor a mobile phone according to a third embodiment of the present invention;

FIG. 6 is a sectional view illustrating a major part of FIG. 5;

FIG. 7 is a sectional view taken along line 1-1 of FIG. 5;

FIG. 8 is an enlarged sectional view of another example of a sound transmission tube of FIG. 7;

FIG. 9 is an exploded perspective view illustrating a connecting part of FIG. 5;

FIG. 10 is a sectional view of an assembled state of FIG. 9; and

FIG. 11 is an enlarged sectional view of a communicating tube.

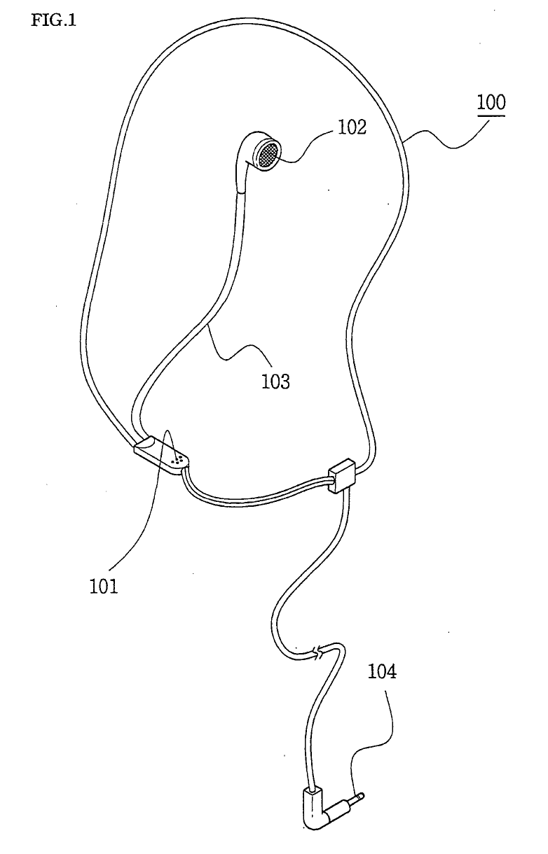

### BEST MODE FOR CARRYING OUT THE INVENTION

Preferred embodiments of the present invention will be described more in detail hereinafter.

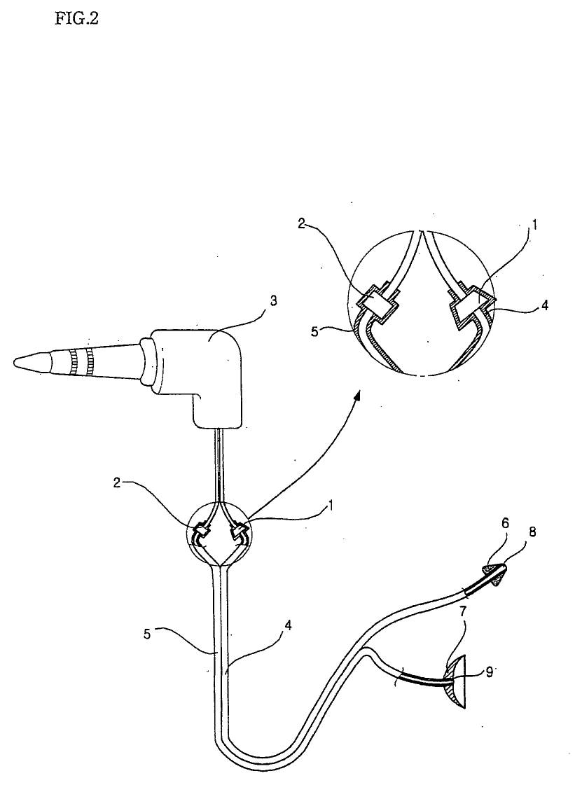

FIG. 2 shows an earphone system for a mobile phone according to a first embodiment of the present invention, in which a speaker 1 and a microphone 2 are connected to a jack 3.

The speaker 1 and the microphone 2 are disposed within nonconductive communication tubes 4 and 5, respectively. An ear inserter 6 and a sound collecting plate 7 are respectively formed on front ends of the communication tubes 4 and 5. The communication tubes 4 and 5 are provided with sound wave passages through which sound wave are transmitted. The jack 3 is coupled to a mobile phone (not shown).

In use, the received sound from the speaker 1 is transmitted to an ear of the user through the communication tubes 4 and the sound wave passage 8, and the transmission sound from the mouth of the user is collected within the sound wave passage 9 through the sound collecting plate 7 and transmitted to the microphone 2 within the communication tube 5, thereby realizing the communication.

As the communication is realized through the ear inserter 6 and the sound collecting palate 7 at a distance enough far from the communication tubes 4 and 5, electron radiation cannot reach the human body.

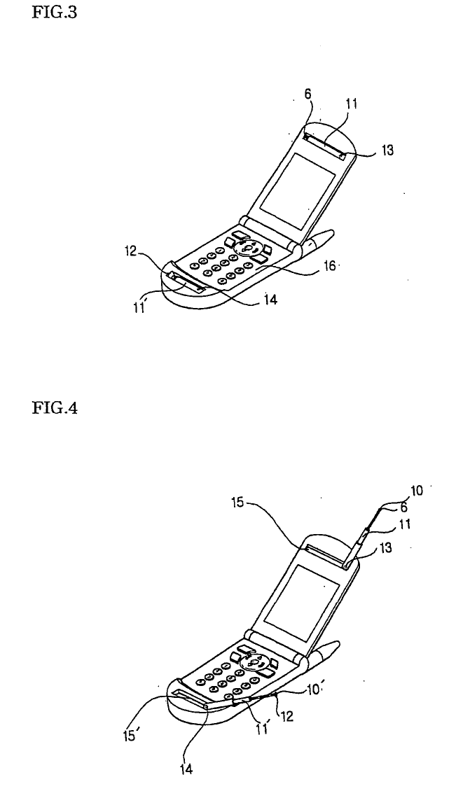

FIGS. 3 and 4 show a second embodiment of the present invention.

As shown in the drawings, nonconductive rod tubes 11 and 11′ are rotatably connected on corresponding positions to receiving and transmission parts 13 and 14 that are formed on a main body of a mobile phone. An ear inserter 6 provided with a sound wave passage 10 is formed on a front end of the rod tube 11 connected to the receiving part 13.

In addition, a collecting plate 12 provided with a sound wave passages 10′ is formed on a front end of the rod tube 11′ connected to the transmission part 14.

The nonconductive rod tubes 11 and 11′ are inserted into insertion grooves 15 and 15′.

In use, as shown in FIG. 4, the user pulls the rod tubes 11 and 11′ such that the sound collecting plate 12 is located close to the mouth and the ear inserter 6 is inserted into the ear.

At this point, as the rod tubes 11 and 11′ defines sound wave passages, the sound is received and transmitted through the sound wave passage, while protecting the user from the harmful electron radiation generated from the mobile phone.

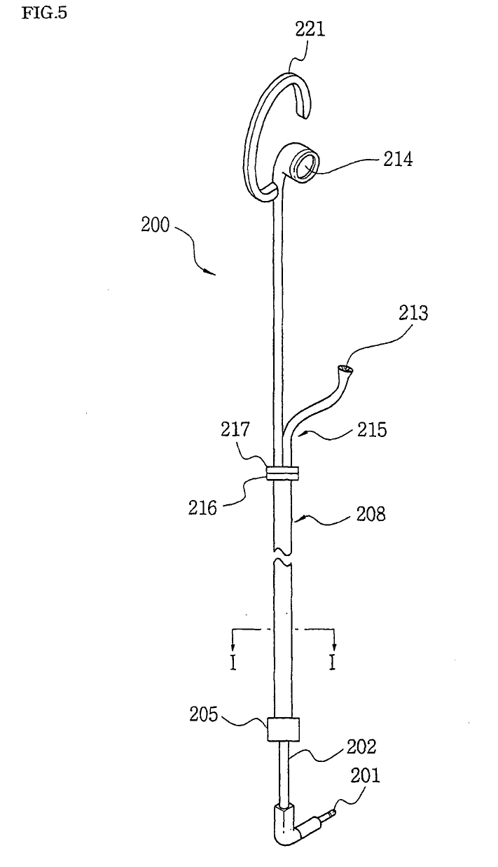

FIGS. 5 to 11 show a third embodiment of the present invention.

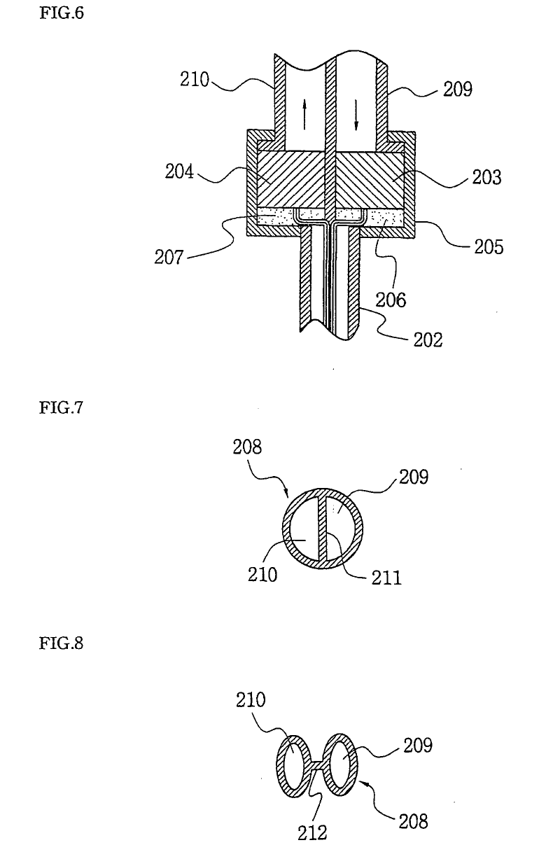

An earphone system 200 includes a jack 201 connectable to a mobile phone and a receivable part 205 in which a microphone 203 and a speaker 204 are separated and disposed as shown in FIG. 6. The receivable part 205 is connected to the jack 201 by an electric wire 202.

A sound wave tube 208 is connected on an upper side of the receivable part 205. The sound wave tube 208 is coupled to the microphone 203 and the speaker 204.

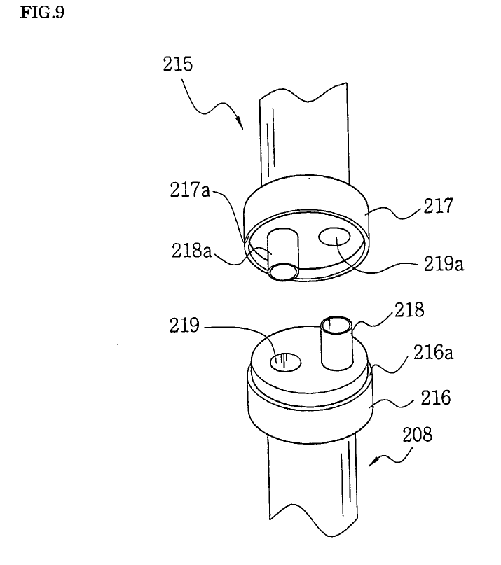

The sound wave tube 208 is separately formed to prevent the communication sound from conflicting. As shown in FIG. 7, a partition 211 is formed within the tube 208 to define a transmission tube 209 and a receiving tube 210. As another example, as shown in FIG. 8, the transmission and receiving tubes 209 and 210 are separately formed and coupled each other by a coupling member 212.

In addition, a communication tube 215 having a transmission part 213 and a receiving part 214 is detachably coupled on the sound wave tube 208.

The detachable coupling is enabled by coupling parts 216 and 217 formed on an upper end of the sound wave tube 208 and on a lower end of the communication tube 215, respectively.

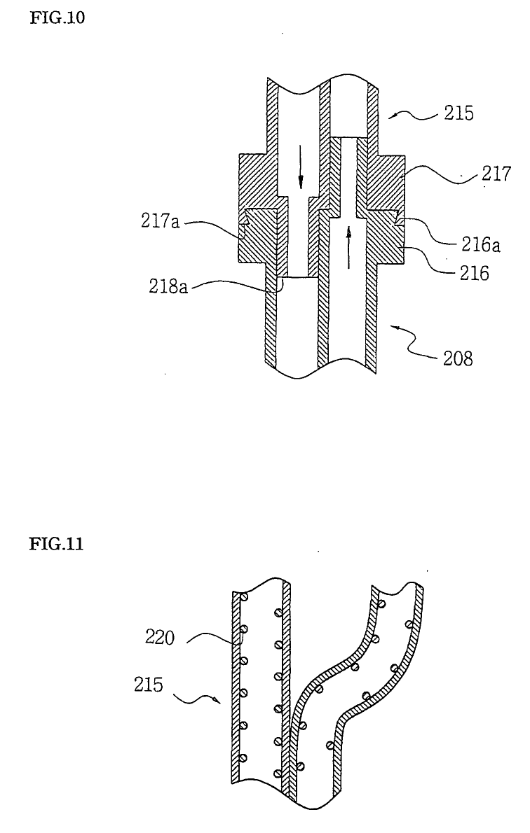

That is, as shown in FIGS. 9 and 10, the coupling part 216 is provided with an insertion tube 218 and a hole 219, and the coupling part 217 is provided with a hole 219a in which the inserting tube 218 is inserted and an insertion tube 218a inserted in the hole 219.

A hook groove 216a is formed on an upper outer circumference of the coupling part 216, and a hook 217a inserted into the hook groove 216a is formed on a lower outer circumference of the coupling part 217 so as to maintain the coupling state of the coupling parts 216 and 217.

In addition, the transmission and receiving parts 213 and 214 of the communication tube 215 should be maintained in a predetermined shape. This is enabled by a spring 220 inserted in the communication tube 215 as shown in FIG. 11.

The spring 220 is preferably formed of a metal and also mounted on an outside of the communication tube 215.

The spring 220 is also mounted on outside and inside of the sound wave tube 208.

That is, the spring 220 prevents the communication tube 215 and the sound wave tube 208 from being bent, thereby preventing the communication sound from being cut during the communication.

The receiving part 214 is provided with an ear hook member 221 so that it can be hooked on the user's ear.

In use, the receiving part 214 is inserted into the ear in a state it is hooked on the user's ear, and the transmission part 213 is located close to the mouth. The receiving sound collected by the transmission part 213 is transmitted to the microphone 203 in the receivable part 205 through the transmission tube 209 and the communication tube 215, then converted into an electric signal and input to the mobile phone. The receiving sound from the speaker from the receivable part 205 is transmitted to the receiving part 214 through the receiving tube 210 and 215 of the sound wave tube 208, thereby realizing the communication.

At this point, as the communication is realized through the sound wave tube 208 and the communication tube 215 at a distance enough far from the microphone 203 and the speaker 204, electron radiation cannot reach the human body.

In addition, the transmission and receiving tubes 209 and 210 are separated from each other by the partition 212, the confliction between the transmission and receiving sounds can be prevented.

Furthermore, since the spring 220 is disposed on an inner or outer sides of the communication tube 215 and the sound wave tube 208, preventing the tubes 215 and 208 from being bent, while maintaining a predetermined shape of the tubes.

### INDUSTRIAL APPLICABILITY

The present invention may be used as an earphone system for portable cassette tape players, portable compact disk players as well as mobile phones.

In addition, the present invention may be used as an earphone for home sound systems.

1. An earphone system for a mobile phone, comprising:
a jack coupled to the mobile phone;
a speaker electrically connected to the jack; and
a microphone electrically connected to the jack,
wherein the speaker and the microphone are inserted in one end of a nonconductive communication tube; and
the communication tube comprises a receiving tube for transmitting sound from the speaker to a user's ear and a transmission tube for transmitting user's transmission sound to the microphone.

2. An earphone system of claim 1 wherein an ear inserter is formed on a front end of the receiving tube, a sound collecting plate is formed on a front end of the transmission tube.

3. An earphone system of claim 1 wherein the communication tube is directly connected to receiving and transmission parts of the mobile phone.

4. An earphone system for a mobile phone, comprising nonconductive rod tubes rotatably connected on corresponding positions to receiving and transmission parts that are formed on a main body of the mobile phone.

5. An earphone system for a mobile phone, comprising:
a jack coupled to the mobile phone;
a speaker electrically connected to the jack;
a microphone electrically connected to the jack;
a receivable part for receiving the speaker and the microphone;
a sound wave tube having receiving and transmission tubes communicating with the microphone and the speaker of the receivable part, respectively; and
a communication tube connected to the transmission and receiving tubes and provided at its front end with receiving and transmission part.

6. An earphone system of claim 5 wherein the sound wave tube includes a first coupling part having a first insertion tube and a first hole, and the communication tube includes a second coupling part having a second insertion tube inserted into the first hole and a second hole in which the first insertion tube is inserted.

7. An earphone system of claim 6 wherein the first coupling part is provided with a hook groove and the second coupling part is provided with a hook hooked on the hook groove.

8. An earphone system of claim 5 wherein a spring is inserted inside the communication tube.

9. An earphone system of claim 5 wherein a spring is inserted outside the communication tube.

10. An earphone system of claim 5 wherein a spring is inserted outside or inside the sound wave tube.

11. An earphone system of claim 5 wherein the receiving part is provided with an ear hook member.

12. An earphone system of claim 5 wherein a partition is disposed inside the sound wave tube to define separated receiving tube and transmission tube.
